(19) United States
(12) Patent Application Publication
(10) Pub. No.: US 2011/0047321 A1
(43) Pub. Date: Feb. 24, 2011

(54) STORAGE PERFORMANCE MANAGEMENT METHOD

(76) Inventors: Yuichi TAGUCHI, Sagamihara (JP); Fumi Fujita, Fujisawa (JP); Masayuki Yamamoto, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/839,746

(22) Filed: Jul. 20, 2010

Related U.S. Application Data
(63) Continuation of application No. 11/520,647, filed on Sep. 14, 2006, now abandoned.

(30) Foreign Application Priority Data
Jul. 26, 2006 (JP) 2006-203185

(51) Int. Cl. G06F 12/02; G06F 12/00; G06F 12/16

(52) U.S. Cl. 711/103; 711/162; 711/E12.001; 711/E12.008; 711/E12.103

(57) ABSTRACT

The computer system having a storage subsystem for storing data in a logical storage extent created in a physical storage device constituted of a physical storage medium, a host computer for reading/writing data from/to the logical storage extent via a network, and a management computer for managing the storage subsystem. The management computer records components of the storage subsystem, a connection relation between the components included in a network path, a correlation between the logical storage extent and the components, and a load of each component, specifies components included in a leading path from an interface through which the storage subsystem is connected with the network to the physical storage medium, measures loads of the specified components to improve performance.

### CROSS REFERENCE TO RELATED APPLICATION

This is a continuation of U.S. application Ser. No. 11/520,647, filed Sep. 14, 2006. This application relates to and claims priority from Japanese Patent Application No. 2006-203185, filed on Jul. 26, 2006. The entirety of the contents and subject matter of all of the above is incorporated herein by reference.

### BACKGROUND

This invention relates to a performance management method for a computer system, and more particularly, to a management method for maintaining optimal system performance.

A storage area network (SAN) is used for sharing one large-capacity storage device by a plurality of computers. The SAN is advantageous in that addition, deletion, and replacement of storage resources and computer resources are easy and extendability is high.

A disk array device is generally used for an external storage device connected to the SAN. Many magnetic storage devices such as hard disks are mounted on the disk array device. The disk array device manages the magnetic storage devices as parity groups each constituted of some magnetic storage devices by a redundant array of independent disks (RAID) technology. The parity group forms one or more logical storage extents. The computer connected to the SAN inputs/outputs data to/from the formed logical storage extent.

If traffic concentrates on a specific part of a path when one or more computers input/output data to/from the external storage device in the SAN, there is a fear that this part become a bottleneck. Accordingly, JP 2004-072135 A discloses a technology of measuring an amount of traffic (transfer rate) passing through a network port (network interface) of the path, and switching to another path when the amount of traffic exceeds a prescribed amount to prevent performance deterioration.

Regarding the storage device, in addition to the magnetic storage device such as a hard disk, there is a storage device on which a semiconductor storage medium such as a flash memory is mounted. The flash memory is used for a digital camera or the like since the flash memory is compact and light as compared with the magnetic storage device. However, the flash memory has not been used so often as an external storage device of a computer system since its capacity is small as compared with the magnetic storage device. Recently, however, a capacity of a semiconductor storage medium such as a flash memory has greatly increased. U.S. Pat. No. 6,529,416 discloses a storage device which includes many flash memories (i.e., memory chips or semiconductor memory devices) and an I/O interface compatible to a hard disk.

### SUMMARY

In the future, a SAN constituted of an external storage device having a semiconductor storage medium will possibly appear in place of the external storage device such as a hard disk. The following problems are conceivable when the performance management technology of JP 2004-072135 A is applied to such the SAN.

In performance management of the disk array device equipped with the hard disks, performance test is carried out for the components of the path leading from the network interface to the hard disks. Thus, the transfer rate through the network interface and operation rates of the hard disks are subjected to inspection of the path. Hence, sections to be inspected may be the network interface and the hard disks.

In the case of the storage device which includes the storage device equipped with the plurality of flash memories in place of the hard disks, mere inspection of an operation rate of the storage device is not enough. To be specific, each flash memory (i.e., memory chip or semiconductor memory device) constituting the storage device must be inspected to specify a faulty part. In the case of the technology disclosed in JP 2004-072135 A, there is included no performance management method for the components in the storage device.

In the performance inspection, it is preferable to correlate performance information of each inspection target place with configuration information of the storage device, and to sequentially trace sections of the path so as to provide a series of operations. However, as no method is available to correlate the flash memory of the storage device with the path, it is impossible to specify a faulty part by a series of drill-down operations.

When a faulty part in performance is specified, it is preferable to optimize a configuration so as to continuously improve performance. According to JP 2004-072135 A, when the network interface of the path is a bottleneck, another path is set to bypass the port. Similarly, when access concentrates on a specific hard disk to make this hard disk a bottleneck, the configuration is changed to distribute access to the other hard disks. The technology disclosed in JP 2004-072135 A lacks performance improvement method which targets the components in the storage device.

Furthermore, such the configuration change requires an elaborate preparation. This is because there is a fear that the performance be deteriorated and data cannot be input/output if the configuration is erroneously changed. Thus, it is preferable that the configuration be changed by giving as little an influence as possible on the system.

This invention therefore provides a performance management technology for a storage system equipped with performance management means and performance improvement means for components in a storage device.

According to a representative embodiment of this invention, there is provided a performance management method for a computer system, the computer system including: a storage subsystem for recording data in a logical storage extent created in a physical storage device constituted of a physical storage medium; a host computer for reading/writing data from/to the logical storage extent of the storage subsystem via a network; and a management computer for managing the storage subsystem and the host computer, the method including:

communicating, by the management computer, with the storage subsystem;

recording, by the management computer, physical storage extent configuration information containing components of the storage subsystem and a connection relation of the components included in a network path through which the host computer reads/writes the data;

recording, by the management computer, logical storage extent configuration information containing correspondence between the logical storage extent and the components;

recording, by the management computer, a load of each component of the storage subsystem as performance information for each of the components;

specifying, by the management computer, components included in a path leading from an interface through which the storage subsystem is connected with the network to the physical storage medium, based on the physical storage extent configuration information and the logical storage extent configuration information, to diagnose a load of the logical storage extent; and

inspecting, by the management computer, loads of the specified components based on the performance information.

According to the embodiment of this invention, it is possible to carry out performance inspection for the components included in the path leading from the network interface to the physical storage medium constituting the physical storage device. Further, the connection information of the components from the physical storage device to the physical storage medium is provided, to thereby make it possible to carry out performance inspection by a series of drill-down operations.

### BRIEF DESCRIPTION OF THE DRAWINGS

FIG. 1 is a diagram showing a configuration of a storage network according to a first embodiment of this invention.

FIG. 2 is a diagram showing a configuration of a storage subsystem according to the first embodiment of this invention.

FIG. 3 is a diagram showing a configuration of a host computer according to the first embodiment of this invention.

FIG. 4 is a diagram showing a configuration of a management computer according to the first embodiment of this invention.

FIG. 5 is a diagram showing a configuration of physical storage extent configuration information according to the first embodiment of this invention.

FIG. 6 is a diagram showing a configuration of logical storage extent configuration information according to the first embodiment of this invention.

FIG. 7 is a diagram showing a configuration of storage volume configuration information according to the first embodiment of this invention.

FIG. 8 is a diagram showing correspondence between a physical storage extent and a logical storage extent according to the first embodiment of this invention.

FIG. 9 is a diagram showing a configuration of network interface performance information according to the first embodiment of this invention.

FIG. 10 is a diagram showing a configuration of physical storage device performance information according to the first embodiment of this invention.

FIG. 11 is a diagram showing a configuration of physical storage medium performance information according to the first embodiment of this invention.

FIG. 12 is a diagram showing a configuration of host computer storage volume configuration information according to the first embodiment of this invention.

FIG. 13 is a diagram showing a configuration of a network interface performance report interface according to the first embodiment of this invention.

FIG. 14 is a diagram showing a configuration of a physical storage device performance report interface according to the first embodiment of this invention.

FIG. 15 is a diagram showing a configuration of a physical storage medium performance report interface according to the first embodiment of this invention.

FIG. 16 is a diagram showing a configuration of network interface performance diagnosis processing according to the first embodiment of this invention.

FIG. 17 is a diagram showing a configuration of physical storage device performance diagnosis processing according to the first embodiment of this invention.

FIG. 18 is a flowchart showing a procedure of physical storage medium performance diagnosis processing according to the first embodiment of this invention.

FIG. 19 is a flowchart showing a procedure of network interface configuration change processing according to the first embodiment of this invention.

FIG. 20 is a flowchart showing a procedure of logical storage extent configuration change processing of moving the physical storage device according to the first embodiment of this invention.

FIG. 21 is a flowchart showing a procedure of logical storage extent configuration change processing of moving the physical storage medium according to the first embodiment of this invention.

FIG. 22A is a diagram showing a configuration of performance threshold information of a network interface according to a second embodiment of this invention.

FIG. 22B is a diagram showing a configuration of performance threshold information of a physical storage device according to the second embodiment of this invention.

FIG. 22C is a diagram showing a configuration of performance threshold information of a physical storage medium according to the second embodiment of this invention.

FIG. 23 is a flowchart showing a procedure of moving destination physical storage medium deciding processing according to the second embodiment of this invention.

FIG. 24 is a flowchart showing a procedure of moving destination physical storage device deciding processing according to the second embodiment of this invention.

### DETAILED DESCRIPTION OF THE PREFERRED EMBODIMENTS

Referring to the drawings, the preferred embodiments of this invention will be described below. It should be noted that the description below is in no way limitative of the invention.

### First Embodiment

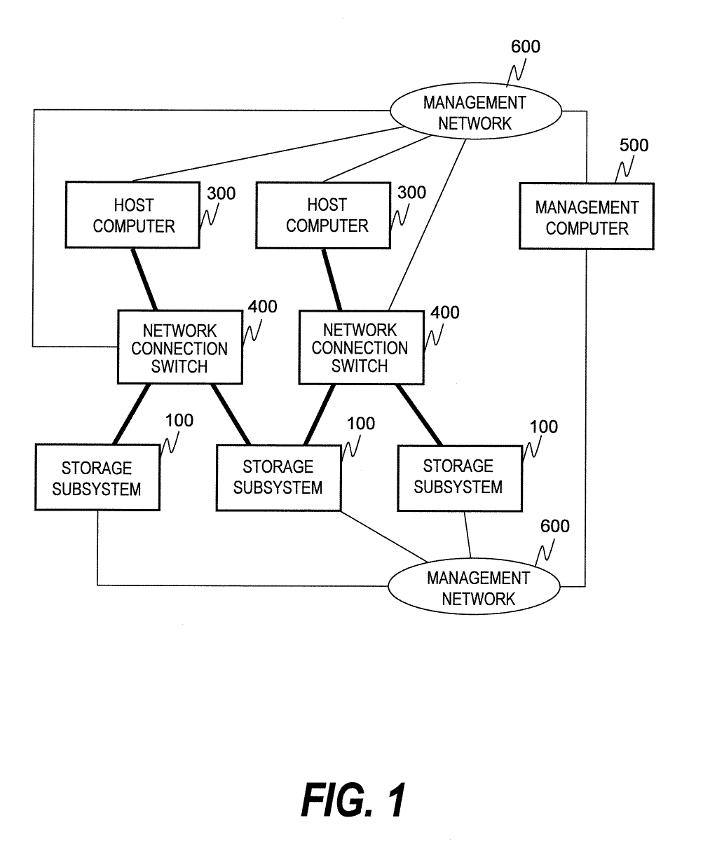

FIG. 1 shows a configuration of a storage area network according to a first embodiment. The storage area network includes a data I/O network and a management network 600.

The data I/O network includes a storage subsystem 100, a host computer 300, and a network connection switch 400. The host computer 300 and the storage subsystem 100 are interconnected via the network connection switch 400 to input/output data to each other. In FIG. 1, the data I/O network is indicated by a thick line. The data I/O network is a network based on a conventional technology such as a fibre channel or Ethernet.

The management network 600 is a network based on a conventional technology such as a fibre channel or Ethernet. The storage subsystem 100, the host computer 300, and the network connection switch 400 are connected to a management computer 500 via the management network 600.

The host computer 300 inputs/outputs data in a storage extent through operation of an application of a database or a file server. The storage subsystem 100 includes a storage device, such as a hard disk drive or a semiconductor memory device, to provide a data storage extent. The network connection switch 400 interconnects the host computer 300 and the storage subsystem 100, and is formed of for example, a fibre channel switch.

According to the first embodiment, the management network 600 and the data I/O network are independent of each other. Alternatively, a single network may be provided to perform both functions.

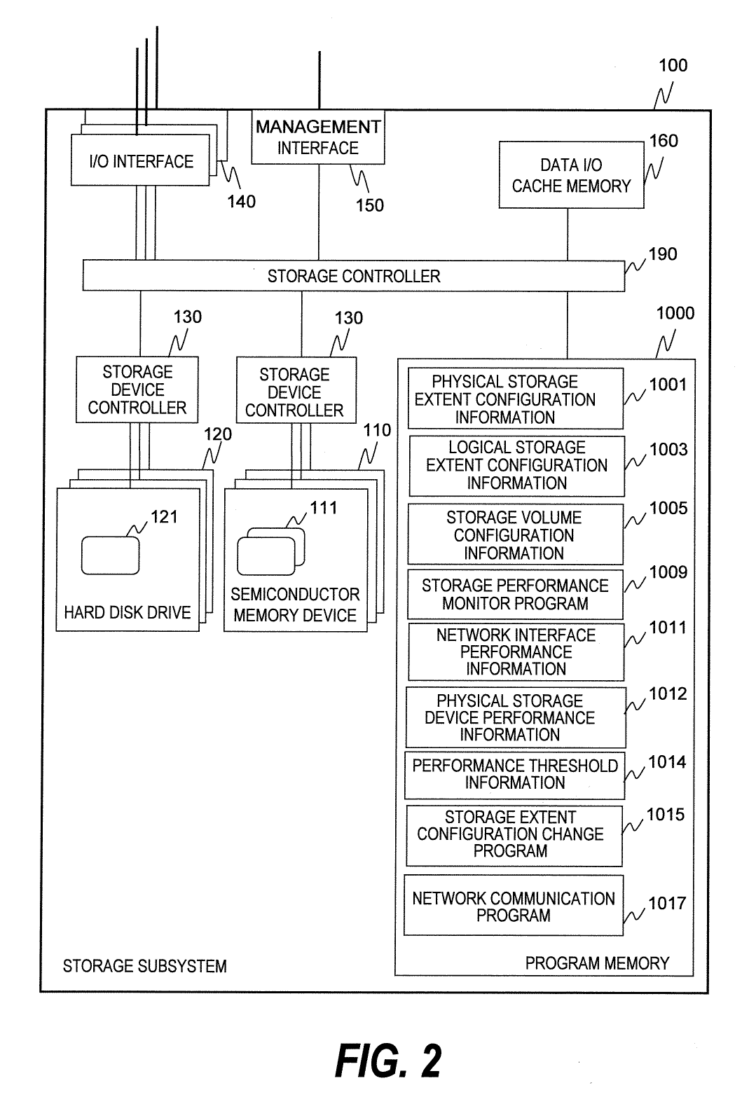

FIG. 2 shows a configuration of the storage subsystem 100 according to the first embodiment. The storage subsystem 100 includes an I/O interface 140, a management interface 150, a storage controller 190, a program memory 1000, a data I/O cache memory 160, and a storage device controller 130. The I/O interface 140, the management interface 150, the program memory 1000, the data I/O cache memory 160, and the storage device controller 130 are interconnected via the storage controller 190.

The I/O interface 140 is connected to the network connection switch 400 via the data I/O network. The management interface 150 is connected to the management computer 500 via the management network 600. The numbers of I/O interfaces 140 and management interfaces 150 are optional. The I/O interface 140 does not need to be configured independent of the management interface 150. Management information may be input/output to/from the I/O interface 140 to be shared with the management interface 150.

The storage controller 190 includes a processor mounted to control the storage subsystem 100. The data I/O cache memory 160 is a temporary storage extent for speeding-up inputting/outputting data from/to a storage extent by the host computer 300. The storage device controller 130 controls the hard disk drive 120 or the semiconductor memory device 110. The data I/O cache memory 160 generally employs a volatile memory. Alternatively, it is also possible to substitute a nonvolatile memory or a hard disk drive for the volatile memory. There is no limit on the number and a capacity of data I/O cache memories 160.

The program memory 1000 stores a program necessary for processing which is executed at the storage subsystem 100. The program memory 1000 is implemented by, a hard disk drive or a volatile semiconductor memory. The program memory 1000 stores a network communication program 1017 for controlling external communication. The network communication program 1017 transmits/receives a request message and a data transfer message to/from a communication target through a network.

The hard disk drive 120 includes a magnetic storage medium 121 constituted of a magnetic disk. Each hard disk drive 120 is provided with one magnetic disk drive 121. The semiconductor memory device 110 includes a semiconductor storage medium 111 such as a flash memory. The semiconductor memory device 111 may include a plurality of semiconductor storage media 111. The magnetic storage medium 121 and the semiconductor storage medium 111 each store data read/written by the host computer 300. Components included in a path leading from the I/O interface 140 to the magnetic storage medium 121 or to the semiconductor storage medium 111 are subjected to performance inspection.

Next, the program and information stored in the program memory 1000 will be described. The program memory 1000 stores, in addition to the above-described network communication program 1017, physical storage extent configuration information 1001, logical storage extent configuration information 1003, storage volume configuration information 1005, a storage performance monitor program 1009, network interface performance information 1011, physical storage device performance information 1012, performance threshold information 1014, and a storage extent configuration change program 1015.

The physical storage extent configuration information 1001 stores configuration information of the hard disk drive 120 and the semiconductor memory device 110 mounted to the storage subsystem 100. The logical storage extent configuration information 1003 stores correspondence between a physical configuration of the storage device and a logical storage extent. The storage volume configuration information 1005 stores correspondence between an identifier added to the logical storage extent provided to the host computer 300 and I/O interface identification information.

The storage performance monitor program 1009 monitors a performance state of the storage subsystem 100. The network interface performance information 1011 stores performance data such as a transfer rate of the I/O interface 140 and a processor operation rate. The network interface performance information 1011 is updated by the storage performance monitor program 1009 as needed. The physical storage device performance information 1012 stores performance data such as a transfer rate of a storage extent and a disk operation rate. The physical storage device performance information 1012 is updated by the storage performance monitor program 1009 as needed.

The performance threshold information 1014 is a threshold of a load defined for each logical storage extent. The storage extent configuration change program 1015 changes a configuration of a storage extent according to a request of the management computer 500.

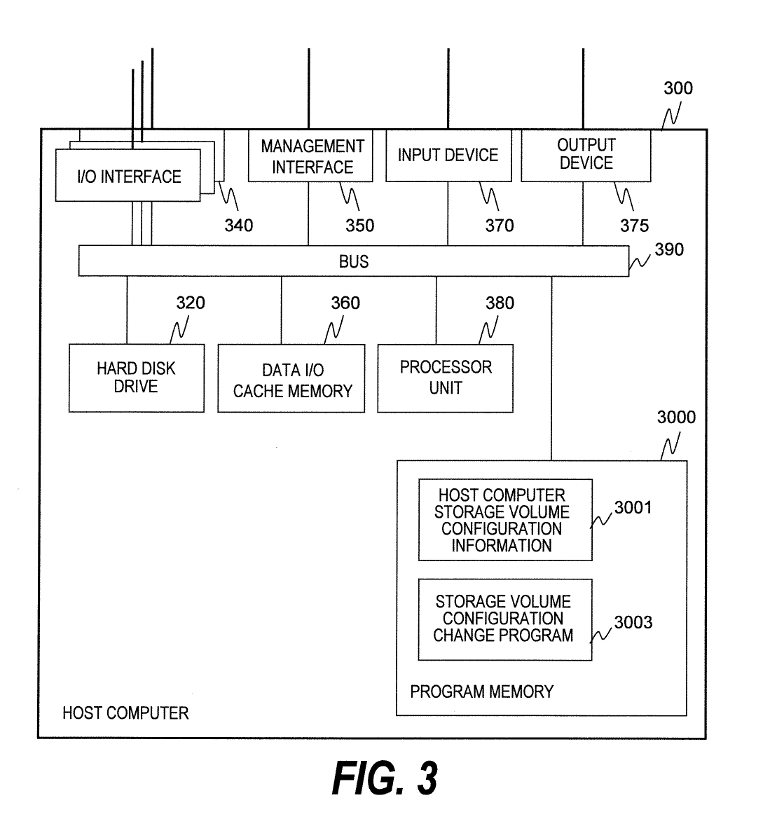

FIG. 3 shows a configuration of the host computer 300 according to the first embodiment. The host computer 300 includes an I/O interface 340, a management interface 350, an input device 370, an output device 375, a processor unit 380, a hard disk drive 320, a program memory 3000, and a data I/O cache memory 360.

The I/O interface 340, the management interface 350, the input device 370, the output deice 375, the processor unit 380, the hard disk drive 320, the program memory 3000, and the data I/O cache memory 360 are interconnected via a network bus 390. The host computer 300 has a hardware configuration to be realized by a general-purpose computer (PC).

The I/O interface 340 is connected to the network connection switch 400 via the data I/O network to input/output data. The management interface 150 is connected to the management computer 500 via the management network 600 to input/output management information. The numbers of I/O interfaces 340 and management interfaces 350 are optional. The I/O interface 340 does not need to be configured independent of the management interface 350. Management information may be input/output to/from the I/O interface 340 to be shared with the management interface 350.

The input device 370 is connected to a device through which an operator inputs information, such as a keyboard and a mouse. The output device 375 is connected to a device through which the operator outputs information, such as a general-purpose display. The processor unit 380 is equivalent to a CPU for performing various operations. The hard disk drive 320 stores software such as an operating system or an application.

The data I/O cache memory 360 is constituted of a volatile memory and the like to speed-up data inputting/outputting. The data I/O cache memory 360 generally employs a volatile memory. Alternatively, it is also possible to substitute a nonvolatile memory or a hard disk drive for the volatile memory. There is no limit on the number and a capacity of data I/O cache memories 360.

The program memory 3000 is implemented by a hard disk drive or a volatile semiconductor memory, and holds a program and information necessary for processing of the host computer 300. The program memory 3000 stores host computer storage volume configuration information 3001 and a storage volume configuration change program 3003.

The host computer storage volume configuration information 3001 stores a logical storage extent mounted in a file system operated in the host computer 300, in other words, logical volume configuration information. The storage volume configuration change program 3003 changes a configuration of a host computer storage volume according to a request of the management computer 500.

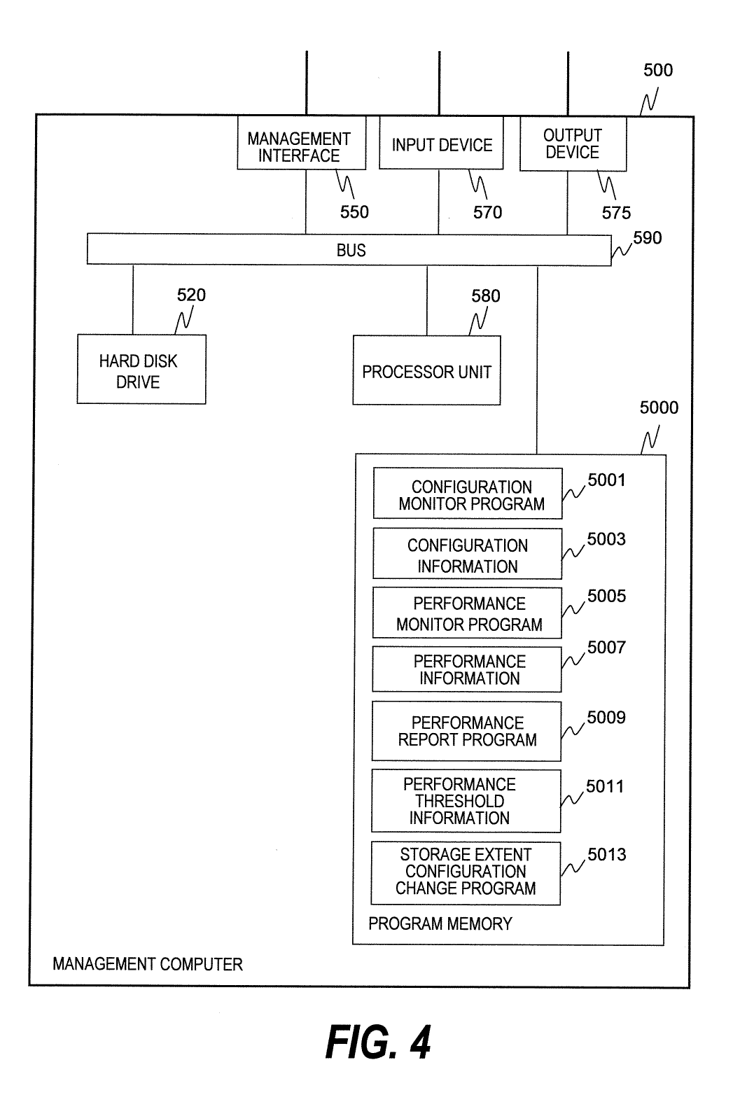

FIG. 4 shows a configuration of the management computer 300 according to the first embodiment. The management computer 500 includes an I/O interface 540, a management interface 550, an input device 570, an output device 575, a processor unit 580, a hard disk drive 520, a program memory 5000, and a data I/O cache memory 560.

The I/O interface 540, the management interface 550, the input device 570, the output deice 575, the processor unit 580, the hard disk drive 520, the program memory 5000, and the data I/O cache memory 560 are interconnected via a network bus 590. The management computer 500 has a hardware configuration to be realized by a general-purpose computer (PC), and a function of each unit is similar to that of the host computer shown in FIG. 3.

The program memory 5000 stores a configuration monitor program 5001, configuration information 5003, a performance monitor program 5005, performance information 5007, a performance report program 5009, performance threshold information 5011, and a storage extent configuration change program 5013.

The configuration monitor program 5001 communicates with the storage subsystem 100 and the host computer 300 which are subjected to monitoring as needed, and refreshes the configuration information up to date. The configuration information 5003 is similar to that stored in the storage subsystem 100 and the host computer 300. To be specific, the configuration information 5003 is similar to the physical storage extent configuration information 1001, the logical storage extent configuration information 1003, and the storage volume configuration information 1005 which are stored in the storage subsystem 100, and the computer storage volume configuration information 3001 stored in the host computer 300.

The performance monitor program 5005 communicates with the storage subsystem 100 as needed and refreshes performance information up to date. The performance information 5007 is similar to the network interface performance information 1011 and the physical storage device information 1012 which are stored in the storage subsystem 100. The performance report program 5009 outputs performance data in the form of a report produced through a GUI or on paper to a user based on the configuration information 5003 and the performance information 5007.

The performance threshold information 5011 is data inputted by a system administrator through the input device 570, and is a threshold of a load defined for each logical storage extent. The storage extent configuration change program 5013 changes a configuration of the logical storage extent defined by the storage subsystem 100, based on the input of the system administrator or the performance threshold information.

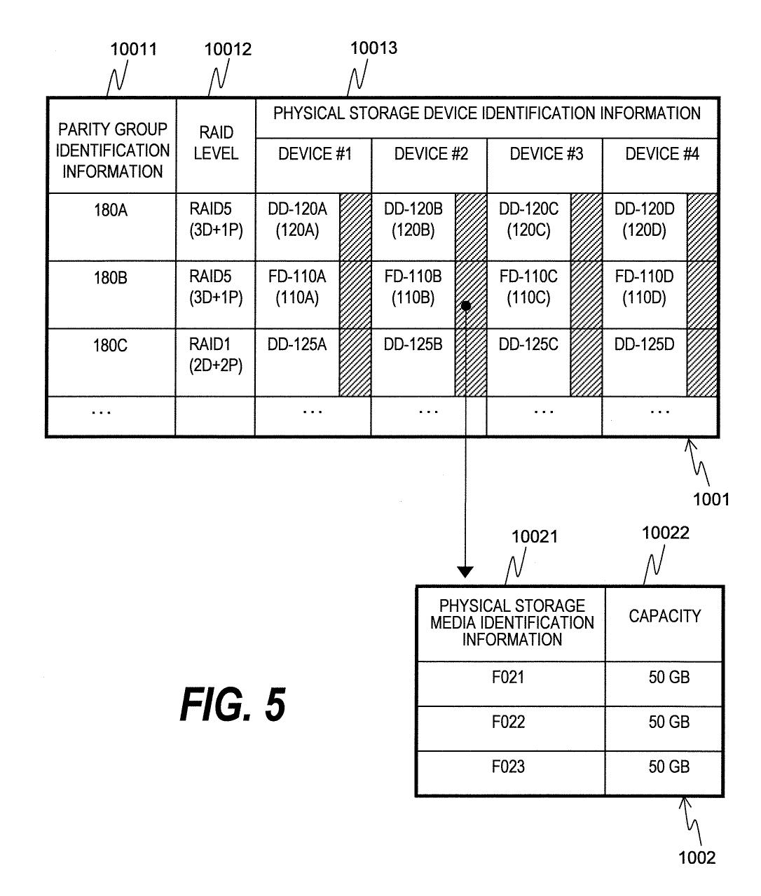

FIG. 5 shows a configuration of the physical storage extent configuration information 1001 according to the first embodiment. The physical storage extent configuration information 1001 includes parity group identification information 10011, a RAID level 10012, and physical storage device identification information 10013.

The parity group identification information 10011 stores an identifier for identifying a parity group. The RAID level 10012 stores a RAID configuration of the parity group.

The physical storage device identification information 10013 stores identification information of a physical storage device constituting the parity group. According to the first embodiment, the hard disk drive 120 and the semiconductor memory device 110 each correspond to the physical storage device.

The physical storage device identification information 10013 includes a pointer to a physical storage medium configuration information 1002 stored in the physical storage device. The physical storage medium configuration information 1002 includes identification information 10021 of the physical storage medium and a storage capacity 10022 of the physical storage medium. Unlike the case of the hard disk drive 120 where one physical storage medium is included in one physical storage device as described above, the semiconductor memory device 110 includes a plurality of physical storage media in one physical storage device. Accordingly, it is possible to execute performance inspection for each physical storage medium unit by using the physical storage medium configuration information 1002 thus provided.

A configuration of a parity group 180B will be described more in detail. The parity group 180B includes four semiconductor memory devices FD-110A to FD-110D. The semiconductor memory device includes a semiconductor memory element such as a flash memory as a physical storage medium. To be specific, as shown in FIG. 5, the semiconductor memory device FD-110B includes three physical storage media F021, F022, and F023.

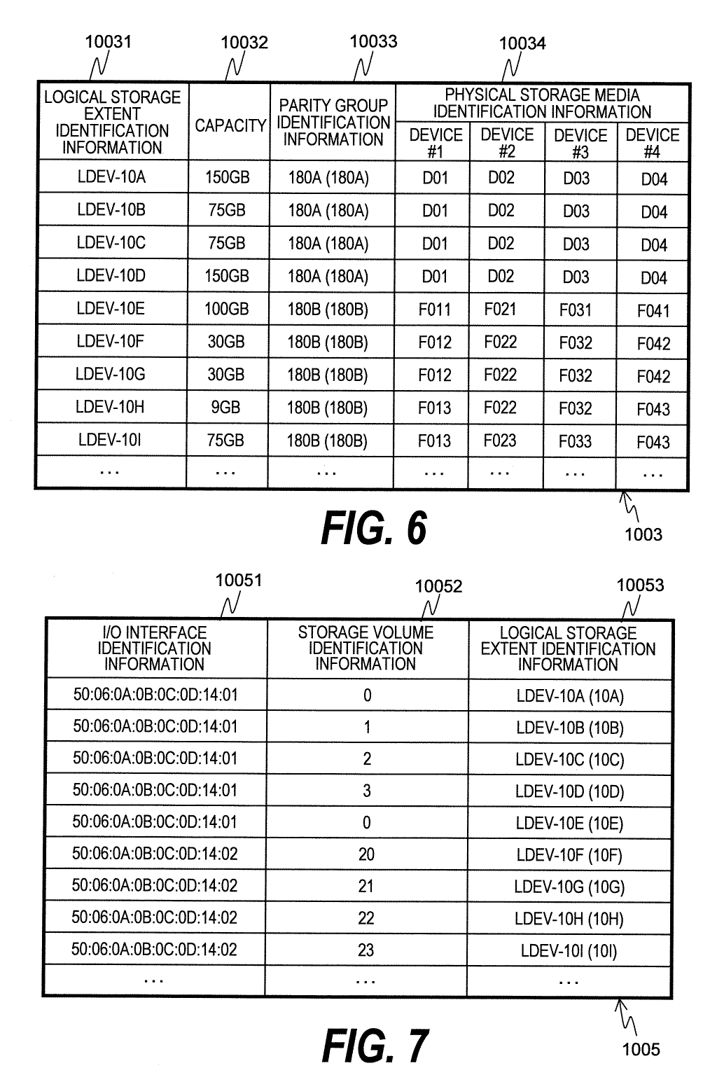

FIG. 6 shows a configuration of the logical storage extent configuration information 1003 according to the first embodiment. The logical storage extent configuration information 1003 stores information regarding a logical storage extent which is a logical storage extent unit defined in the physical storage device.

The logical storage extent configuration information 1003 includes logical storage extent identification information 10031, a capacity 10032, parity group identification information 10033, and physical storage media identification information 10034. The logical storage extent identification information stores an identifier of a logical storage extent. The capacity 10032 stores a capacity of the logical storage extent. The parity group identification information 10033 stores an identifier of a parity group to which the logical storage extent belongs. The physical storage media identification information 10034 stores an identifier of a physical storage medium which stores the logical storage extent.

FIG. 7 shows a configuration of the storage volume configuration information 1005 according to the first embodiment. The storage volume configuration information 1005 includes identification information 10051 of the I/O interface 140, storage volume identification information 10052, and identification information 10053 of the logical storage extent. The storage volume identification information 10052 is an identifier of a storage volume to be provided to the host computer 300. The storage volume configuration information 1005 stores correspondence among the I/O interface 140, the storage volume, and the logical storage extent.

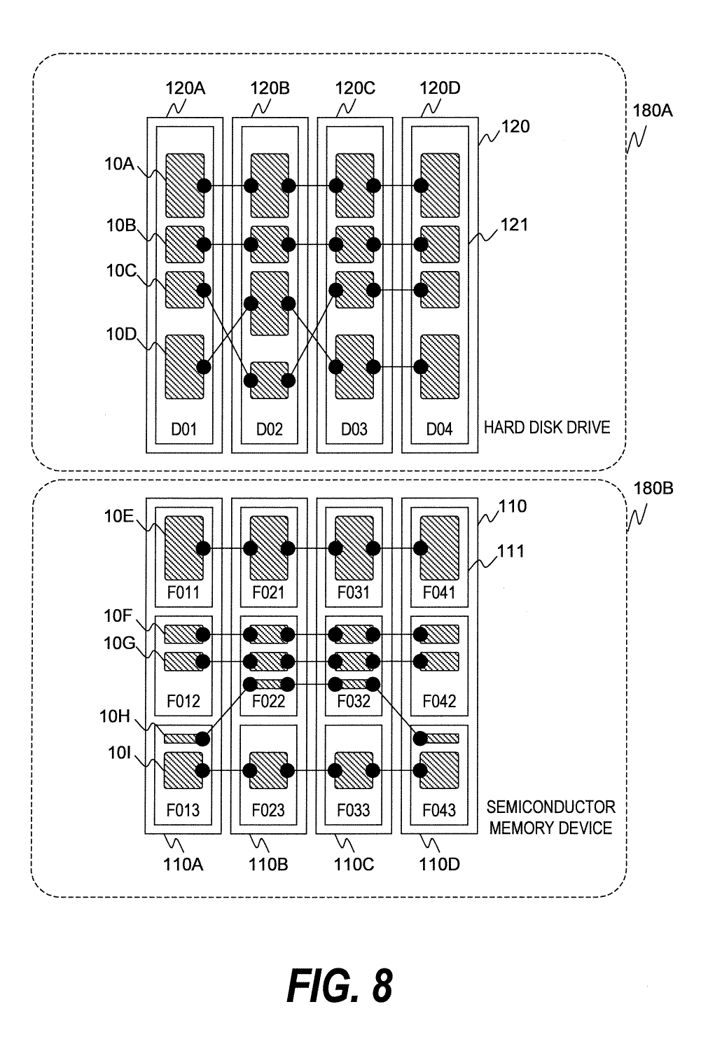

FIG. 8 shows a relation between the physical and logical storage extents according to the first embodiment. Referring to FIG. 8, the relation between the physical storage extents and the logical storage extents will be described for the parity groups 180A and 180B.

The parity group 180A includes four physical storage devices 120A, 120B, 120C, and 120D. Similarly, the parity group 180B includes four physical storage devices 110A, 110B, 110C, and 110D. A physical storage device constituting the parity group 180A is the hard disk drive 120. On the other hand, a physical storage device constituting the parity group 180B is the semiconductor memory device 110. The semiconductor memory device 110 includes a semiconductor memory element equivalent to a physical storage medium.

A logical storage extent LDEV-10H included in the parity group 180B includes physical storage media F013 included in the physical storage device 110A, physical storage media F022 included in the physical storage device 110B, and physical storage media F043 included in the physical storage device 110D.

Referring to FIG. 7, the logical storage extent LDEV-10H is correlated to I/O interfaces “50:06:0A:0B:0D:14:02” of the storage subsystem 100. The host computer 300 is connected with a storage volume 22 correlated to the I/O interface “50:06:0A:0B:0C:0D:14:02” to be permitted to read/write data stored from/to the logical storage extent LDEV-10H.

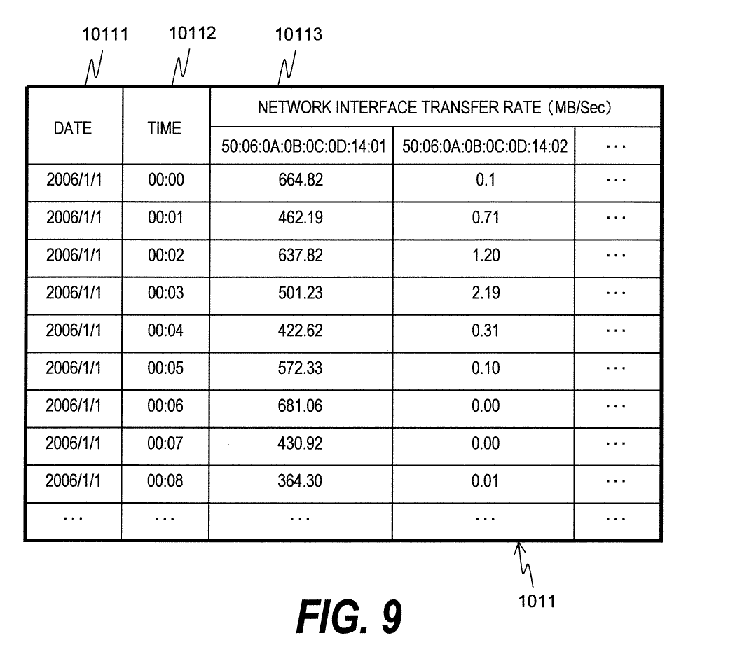

FIG. 9 shows the network interface performance information 1011 according to the first embodiment. In the network interface performance information 1011, an observed value of an amount of data transferred via the I/O interface 140 is stored by the storage performance monitor program 1009. When a transfer rate is recorded at each regular observation time interval as in the case of the first embodiment, a length of observation time is properly decided, and no particular limit is placed. According to the first embodiment, observation time is one minute.

According to the first embodiment, the performance data of the network interface is represented by the transfer rate. However, an observation performance index may be the number of inputs/outputs or a processor operation rate for each unit time.

The physical storage device performance information of the first embodiment is formed into a tiered table configuration. The physical storage device performance information 1012 includes performance information 1012A of each parity group, performance information 1012B of each physical storage device, performance information 1012C of each physical storage medium, and performance information 1012D of each logical storage extent.

The physical storage device performance information stores a data amount read/written from/to the physical storage device as a transfer rate. The transfer rate is observed by the storage performance monitor program 1009.

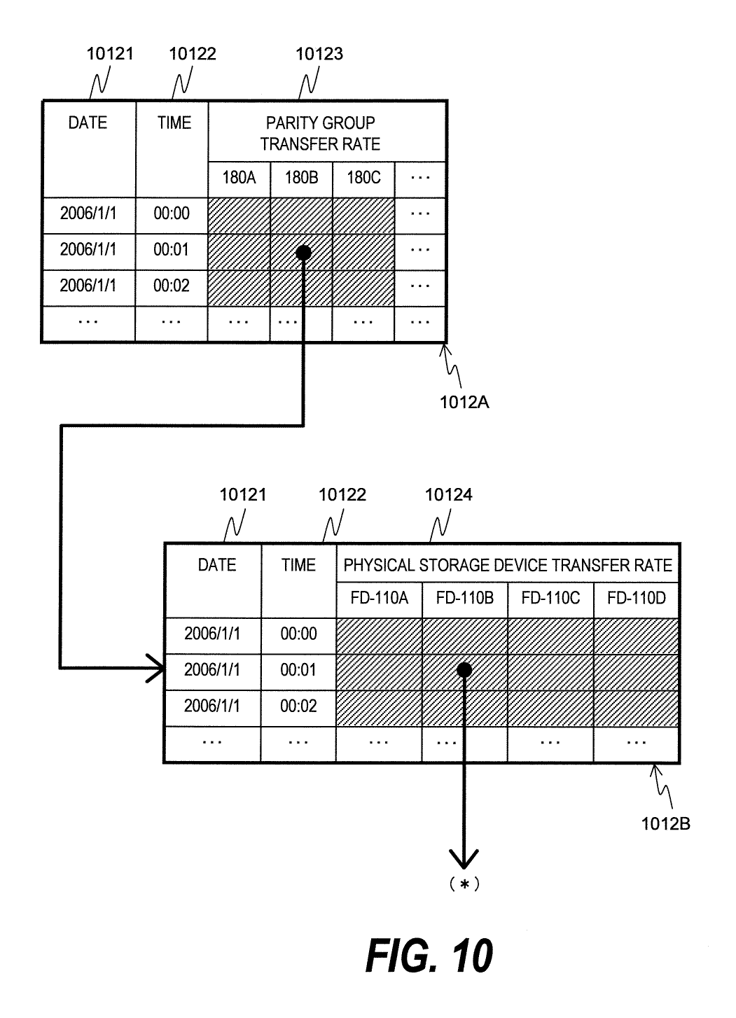

FIG. 10 shows the pieces of physical storage device performance information 1012A and 1012B according to the first embodiment. Physical storage devices correspond to the hard disk drive 120 and the semiconductor memory device 110 which are mounted in the storage subsystem 100.

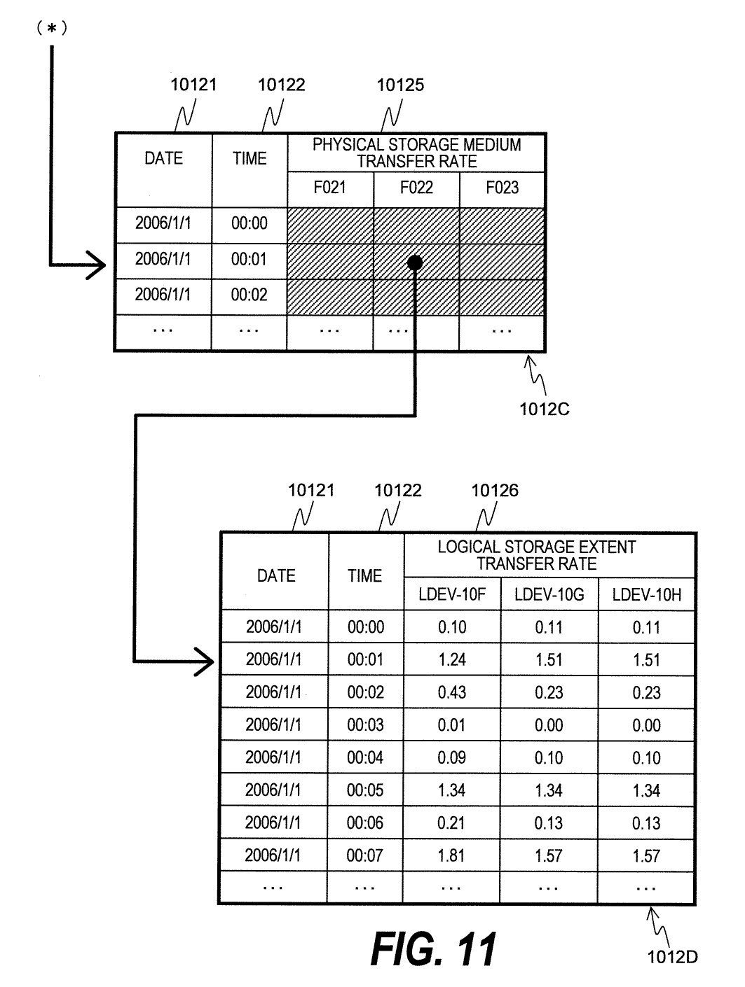

FIG. 11 shows the pieces of physical storage medium performance information 1012C and 1012D according to the first embodiment. In the semiconductor memory device, since the physical storage device includes a plurality of physical storage media as described above, the number of tiers to be managed is increased by one compared with that of the hard disk drive.

The physical storage device performance information 1012A to 1012D includes an observation day 10121, time 10122, and transfer rates 10123 to 10126 of tables.

As described above, the physical storage device information is tiered, and a parity group transfer rate 10123 matches a sum of physical storage device transfer rate 10124 of the same observation time. A relation between the parity group and the physical storage device is defined by the physical storage extent configuration information 1001. To be specific, as the parity group 180B includes the physical storage devices FD-110A to FD-110D, a sum total of transfer rates of the physical storage devices FD-110A to FD-110D of the same time becomes a transfer rate of the parity group 180B.

Similarly, a physical storage device transfer rate 10124 matches a sum of physical storage medium transfer rates 10125 of the same observation time. A relation between the physical storage device and the physical storage medium is defined by the logical storage extent configuration information 1003. Similarly, the physical storage medium transfer rate 10125 matches a sum of logical storage extent transfer rates 10126 of the same observation time. A relation between the physical storage medium and the logical storage extent is defined by the logical storage extent configuration information 1003.

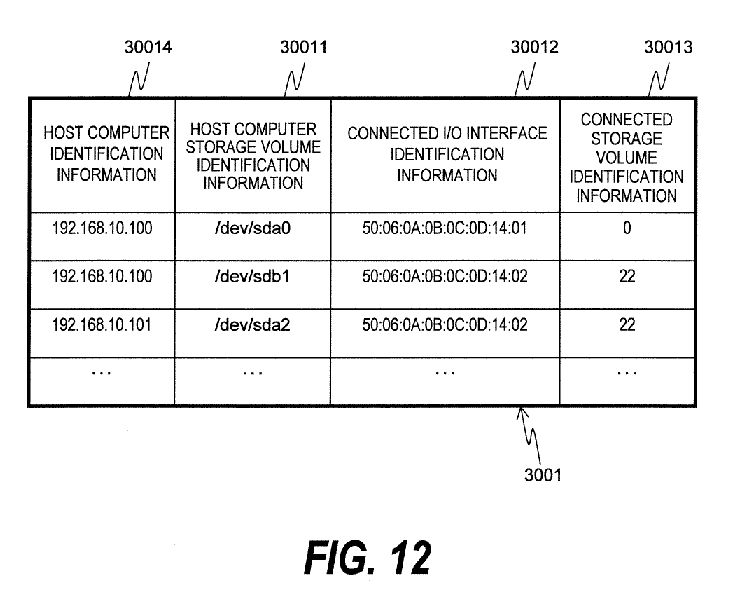

FIG. 12 shows a configuration of the host computer storage volume configuration information 3001 according to the first embodiment. The host computer storage volume configuration information 3001 stores a configuration of a storage volume read/written by the host computer 300.

The host computer storage volume configuration information 3001 includes host computer identification information 30014, computer storage volume identification information 30011, connected I/O interface identification information 30012, and connected storage volume identification information 30013.

The host computer identification information 30014 is an identifier of the host computer 300. The host computer storage volume identification information 30011 stores an identifier of a storage volume accessed from the host computer 300.

The connected I/O interface identification information 30012 stores an identifier for uniquely identifying the connected I/O interface 140 of the storage subsystem. The connected storage volume identification information 30013 stores an identifier of a storage volume provided from the storage subsystem 100 to the host computer 300.

For example, referring to FIG. 12, a storage volume 22 accessed via the I/O interface “50:06:0A:0B:0C:14:02” can be used as “/dev/sdb1” in the file system of the host computer 300. As shown in FIG. 7, the storage volume whose identification information is “22” corresponds to the logical storage extent LDEV-10H.

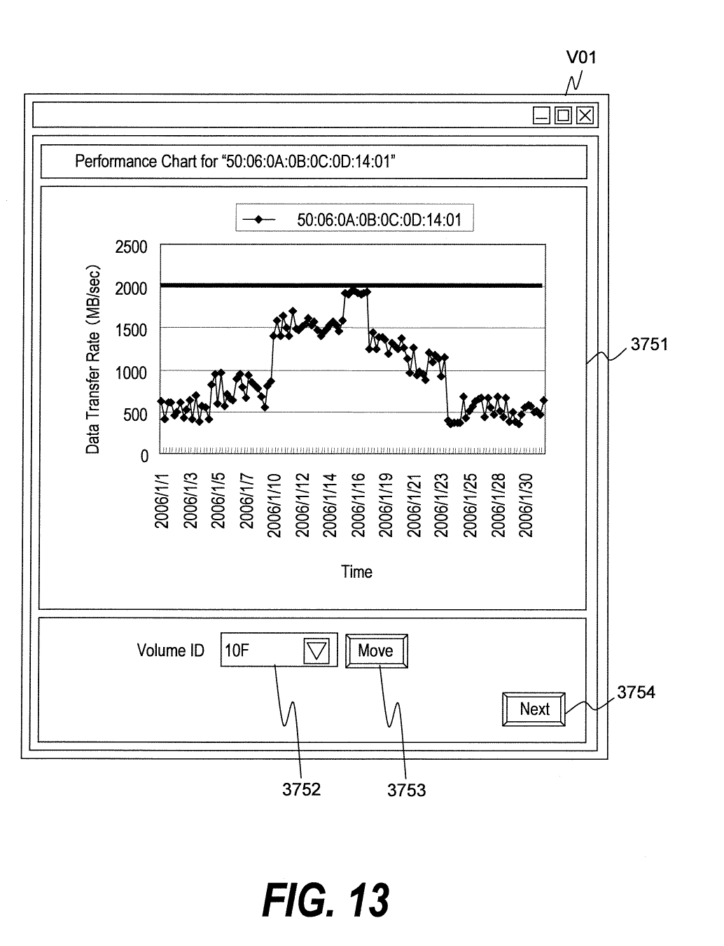

FIG. 13 shows the network interface performance report interface V01 according to the first embodiment. The network interface performance report interface V01 is output from the output device 375 of the management computer 500. The network interface performance report interface V01 includes an actual performance chart display unit 3751, a moving destination volume ID designation section 3752, a Move button 3753, and a Next button 3754. When the Move button 3753 is operated, a designated storage volume can be moved to another I/O interface. When the Next button 3754 is operated, actual performance of each physical storage device can be referred to.

When the system administrator designates an identifier of a storage volume to refer to actual performance, the management computer 500 refers to the host computer storage volume configuration information 3001 to specify an identifier of a corresponding I/O interface. The management computer 500 obtains the network interface performance information 1011 based on the specified identifier of the I/O interface. Then, the management computer 500 displays an actual performance chart on the actual performance chart display unit 3751 by the performance report program 5009.

In this case, a storage extent designated by the system administrator is set to be “/dev/sdb1”. Referring to the host computer storage volume configuration information 3001 shown in FIG. 12, an I/O interface becomes “50:06:0A:0B:0C:0D:14:02”. As the connected storage volume identification information 30013 is “22”, referring to the storage volume configuration information 1005, the storage extent corresponds to the logical storage extent LDEV-10H.

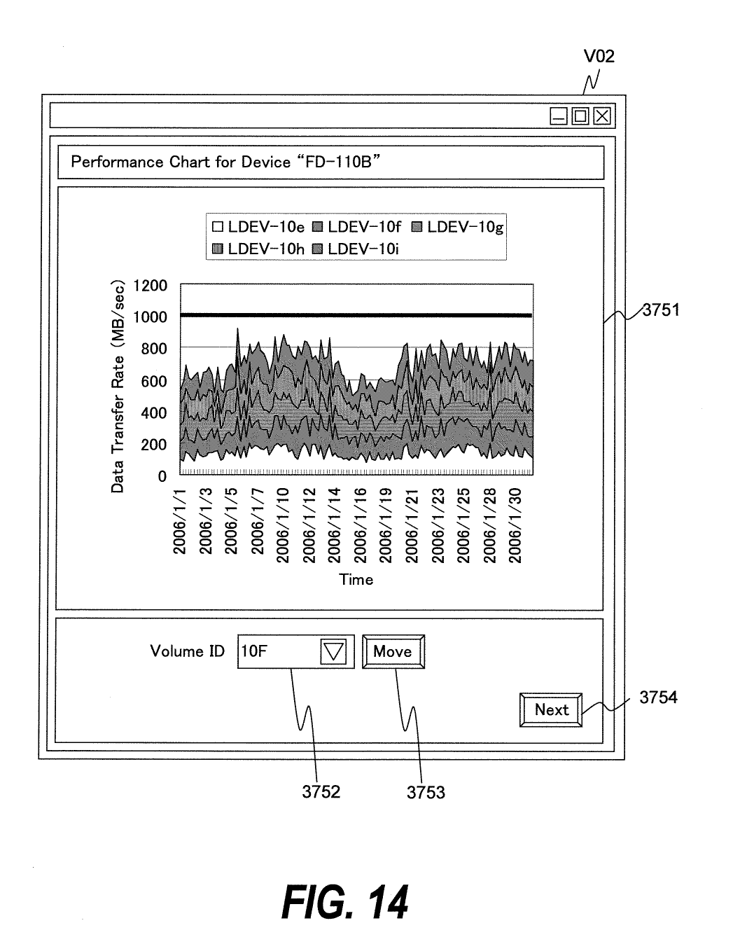

FIG. 14 shows the physical storage device performance report interface V02 according to the first embodiment.

The physical storage device performance report interface V02 is displayed by operating the Next button 3754 of the network interface performance report interface V01. The physical storage device performance report interface V02 outputs an actual performance chart of a physical storage device which stores a designated storage volume. Referring to FIGS. 7 and 6, storage volume “22”, i.e., physical storage devices which store the logical storage extent LDEV-10H, become FD-110A, FD-110B, FD-110C, and FD-110D. In FIG. 14, actual performance of the logical storage extents LDEV-10E to LDEV-10I stored in the FD-110B by a cumulative chart.

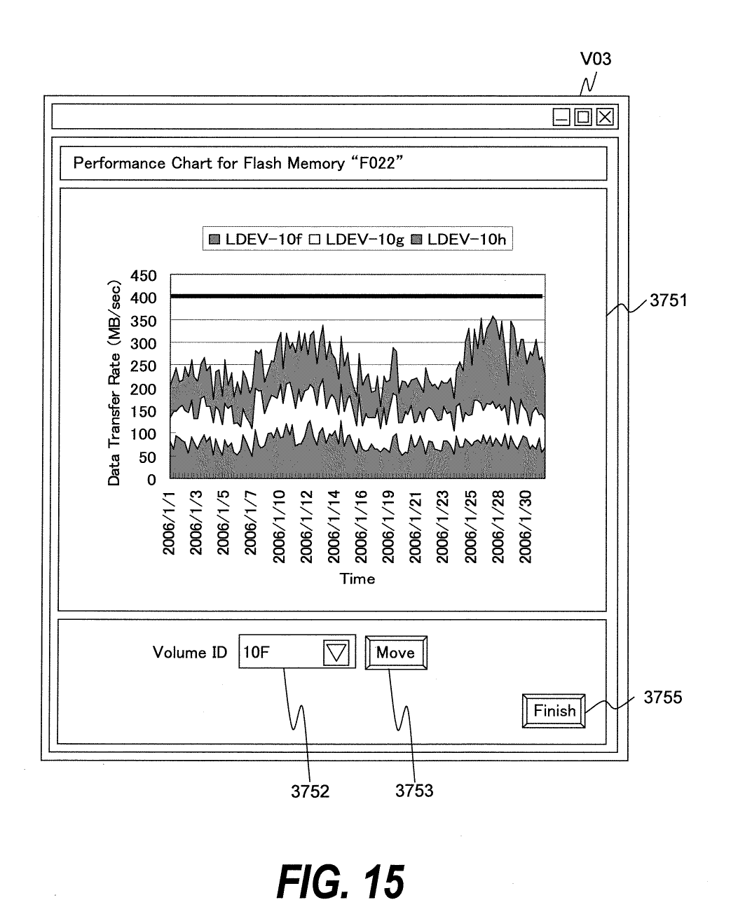

FIG. 15 shows an example of the physical storage medium performance report interface V03 according to the first embodiment.

The physical storage medium performance report interface V03 is displayed by operating the Next button 3754 of the physical storage device performance report interface V02. The physical storage medium performance report interface V03 outputs an actual performance chart of a physical storage medium which stores a designated storage volume. Referring to FIG. 6, physical storage extents to store the storage volume “22” become F013, F022, F032, and F043. In FIG. 15, actual performance of logical storage extents LDEV-10F, LDEV-10G, and LDEV-10H stored in the F022 is represented by a cumulative chart. Then, when the Finish button 3755 is operated, the physical storage medium performance report interface V03 finishes the performance inspection.

Next, an operation procedure of the system administrator when performance determination processing is executed will be described.

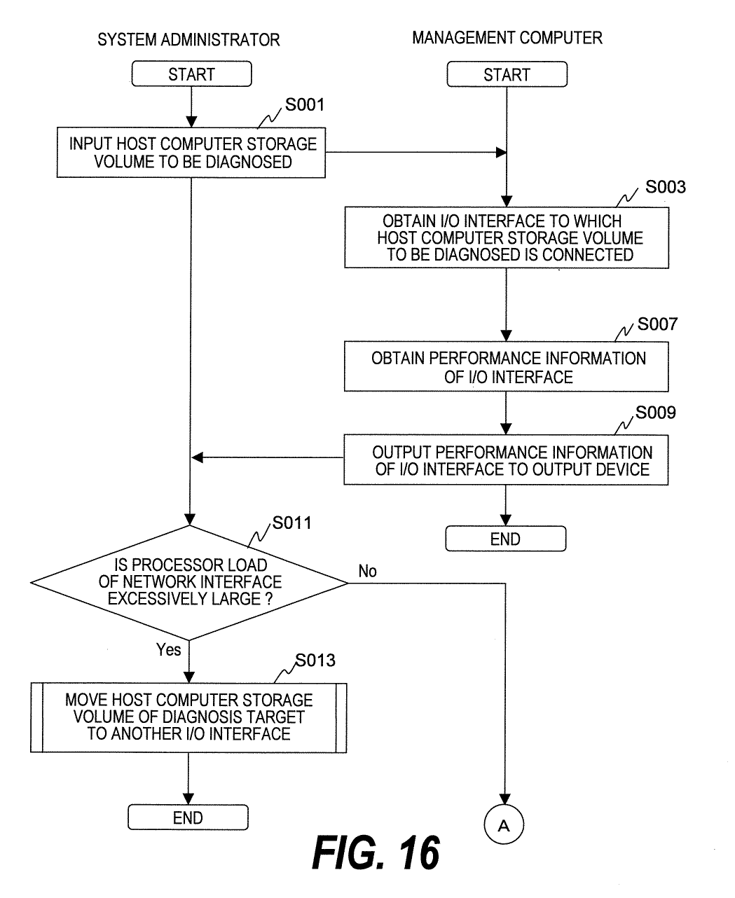

FIG. 16 is a flowchart showing a procedure of outputting I/O interface performance information according to the first embodiment.

The system administrator inputs identification information of a host computer storage volume to be subjected to load determination by the input device 570 (S001). For example, “/dev/sdb1” of the host computer storage volume identification information 30011 of the host computer storage volume configuration information 3001 shown in FIG. 12 is input.

The management computer 500 refers to the host computer storage volume configuration information 3001 included in the configuration information 5003 to obtain the I/O interface 140 to which the host computer storage volume input in the processing of S001 (S003). For example, as shown in FIG. 12, the I/O interface 140 to which “/dev/sdb1” is connected becomes “50:06:0A:0B:0C:0D:14:02”.

The management computer 500 refers to the network interface performance information 1011 to obtain performance information of the I/O interface 140 obtained in the processing of S003 (S007). Then, the management computer 500 displays the performance information of the I/O interface 140 obtained in the processing of S007 in the network interface performance report interface V01 via the output device 575 (S009).

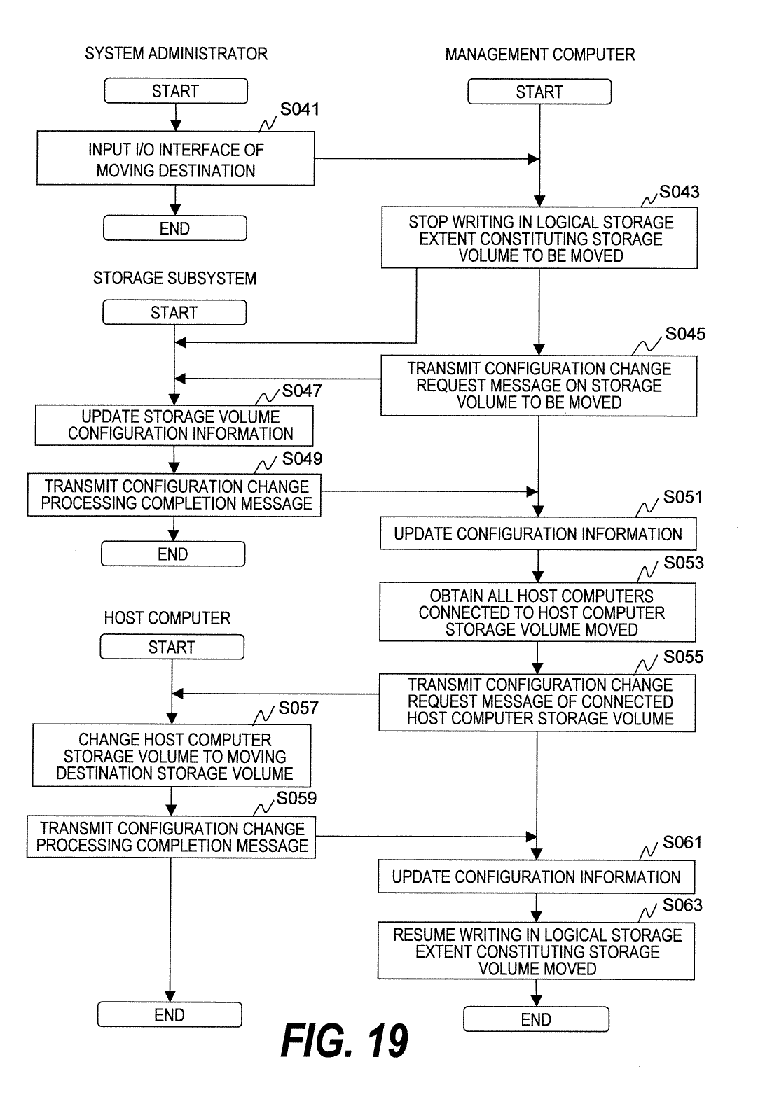

Subsequently, the system administrator refers to the network interface performance report interface V01 to determine whether a load of the I/O interface is excessively large (S011). When the load of the connected I/O interface 140 is determined to be excessively large (result of S011 is “Yes”), the system administrator executes processing of connecting a logical storage extent to another I/O interface 140 (S013). The processing of connecting the logical storage extent to another I/O interface 140 is executed by operating the Move button 3753 of the network interface performance report interface V01. A procedure of movement processing will be described below referring to FIG. 19.

When referring to performance information of each physical storage device, the system administrator operates the Next button 3754 to display the physical storage device performance report interface V02.

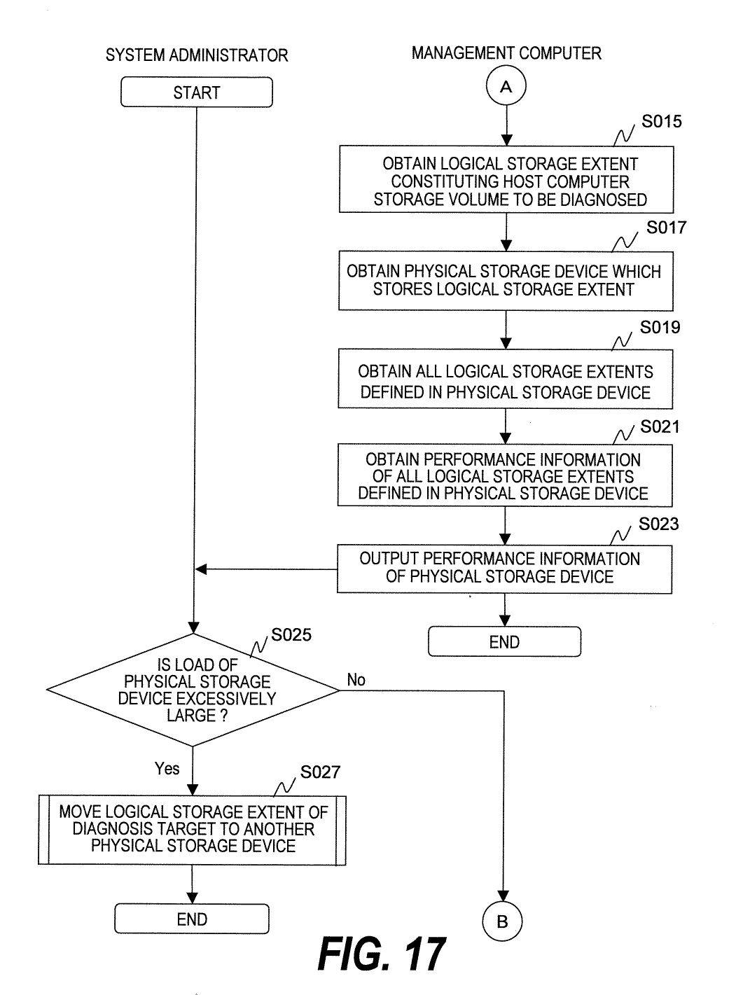

FIG. 17 is a flowchart showing a procedure of the physical storage device performance information according to the first embodiment.

When the load of the I/O interface 140 is determined not to be excessively large (result of 5011 shown in FIG. 16 is “No”), the management computer 500 obtains a logical storage extent constituting a host computer storage volume of a diagnosis target (S015). For the host computer storage volume of the diagnosis target, a value input by the processing of 5001 shown in FIG. 16 is used.

To obtain the logical storage extent constituting the host computer storage volume, the management computer 500 refers to the host computer storage volume 3001 to obtain a connected storage volume 30013 equivalent to the host computer storage volume of the diagnosis target. Then, the management computer 500 retrieves a relevant logical storage extent from the storage volume configuration information 1005.

To be specific, when “/dev/sdb1” is designated as the host computer storage volume of the diagnosis target, referring to the host computer storage volume 3001, the connected I/O interface 140 becomes “50:06:0A:0B:0C:0D”, and the connected storage volume becomes “22”. When the logical storage extent whose connected storage volume is “22” is retrieved from the storage volume configuration information 1005, the logical storage extent is “LDEV-10H”.

The management computer 500 refers to the physical storage extent configuration information 1001 and the logical storage extent configuration information 1003 to obtain a physical storage device constituting the logical storage extent obtained in the processing of S015 (S017). To be specific, a parity group including “LDEV-10H” is “180B” when referring to the parity group identification information 10033 of the logical storage extent configuration information 1003. Referring to the physical storage device identification information 10013 of the physical storage extent configuration information 1001, physical storage devices constituting the parity group “180B” are “FD-110A”, “FD-110B”, “FD-110C”, and “FD-110D”.

The management computer 500 refers to the logical storage extent configuration information 1003 to obtain a physical storage device, i.e., a logical storage extent defined for the parity group (S019). To be specific, logical storage extents belonging to the parity group “180B” are “LDEV-10E”, “LDEV-10F”, “LDEV-10G”, “LDEV-10H”, and “LDEV-10I”.

The management computer 500 refers to the performance information 5007 to obtain performance information of the logical storage extents obtained in the processing of S019 (S021). Then, the management computer 500 displays performance information of the physical storage device in the physical storage device performance report interface V02 based on an integrated value of the performance information of the logical storage extents obtained in the processing of 5021 via the output device 575 (S023).

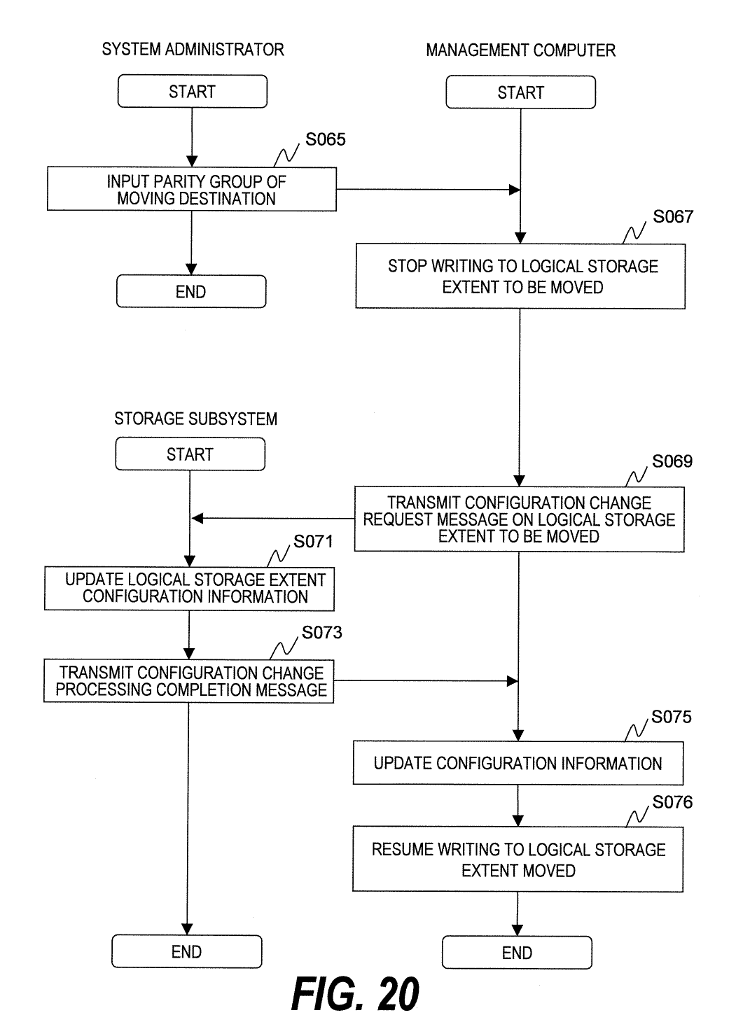

Subsequently, the system administrator refers to the physical storage device performance report interface V02 to determine whether a load of the physical storage device is excessively large (S025). When the load of the physical storage device is determined to be excessively large (result of S025 is “Yes”), the system administrator executes processing of moving the logical storage extent to the physical storage device, i.e., the parity group (S027). The processing of moving the logical storage extent to another parity group is executed by operating the Move button 3753 of the physical storage device performance report interface V02. A procedure of the movement processing will be described below referring to FIG. 20.

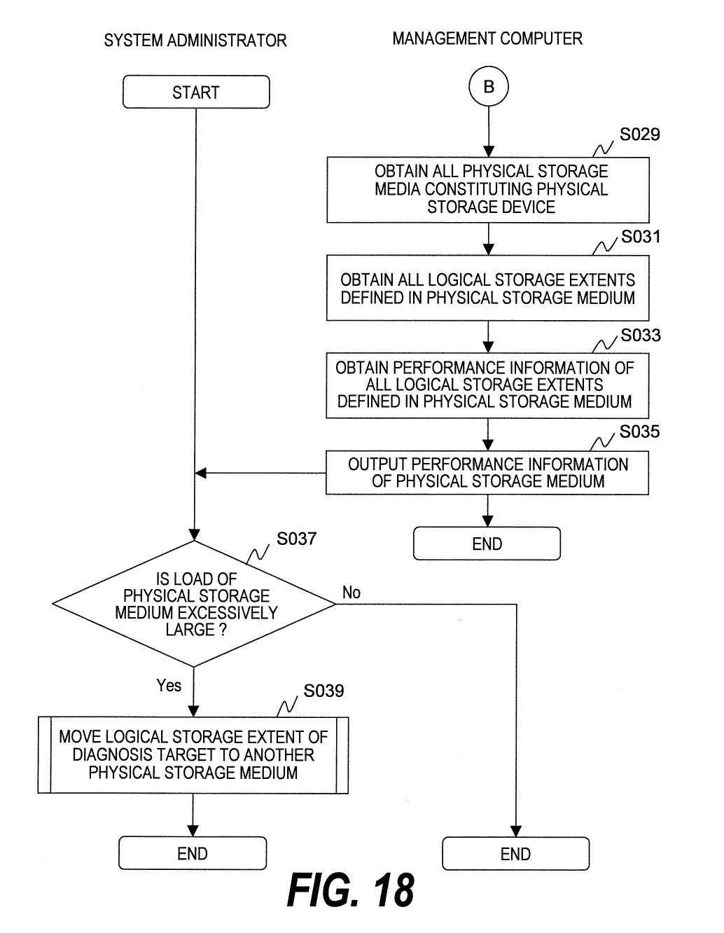

FIG. 18 is a flowchart showing a procedure of outputting performance information of a physical storage medium according to the first embodiment.

When the load of the physical storage device is determined not to be excessively large (result of S025 shown in FIG. 17 is “No”), the management computer 500 obtains a physical storage medium constituting the physical storage device obtained in S017 shown in FIG. 17 (S029). To obtain the physical storage medium constituting the physical storage device, the management computer 500 refers to the physical storage media identification information 10021 of the physical storage extent configuration information 1001. For example, when a physical storage device of a diagnosis target is “FD-110B”, physical storage media mounted on the physical storage device become “F021”, “F022”, and “F023”.

Subsequently, the management computer 500 executes processing below for all the physical storage media obtained in the processing of 5029.

The management computer 500 refers to the logical storage extent configuration information 1003 to obtain logical storage extents defined in the physical storage media obtained in the processing of 5029 (S031). For example, logical storage extents defined in the physical storage medium “F022” are “LDEV-10F”, “LDEV-10G, and “LDEV-10H”.

The management computer 500 refers to the performance information 5007 to obtain performance information of the logical storage extents obtained in the processing of S031 (S033). Then, the management computer 500 displays performance information of the physical storage device in the physical storage medium performance report interface V03 based on an integrated value of the performance information of the logical storage extents obtained in the processing of S033 via the output device 575 (S035).

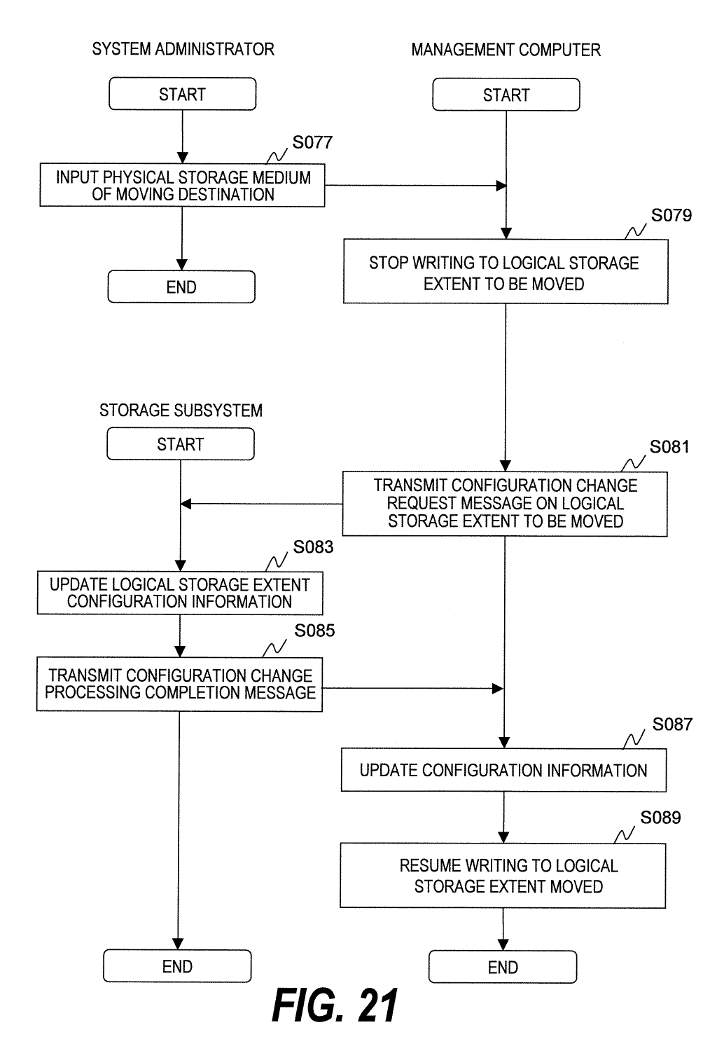

Subsequently, the system administrator refers to the physical storage medium performance report interface V03 to determine whether a load of the physical storage medium is excessively large (S037). When the load of the physical storage medium is determined to be excessively large (result of S037 is “Yes”), the system administrator executes processing of moving the logical storage extent to another physical storage medium (S039). The processing of moving the logical storage extent to another physical storage medium is executed by operating the Move button 3753 of the physical storage medium performance report interface V03. A procedure of the movement processing will be described below referring to FIG. 21.

FIG. 19 is a flowchart showing processing of moving a connecting destination of a storage volume to a different I/O interface 140 according to the first embodiment. The processing shown in FIG. 19 corresponds to the processing of 5013 shown in FIG. 16.

The system administrator inputs an I/O interface 140 of a moving destination from the input device 570 of the management computer 500 (S041). The management computer 500 temporarily stops writing in a logical storage extent constituting a storage volume of a moving target (S043). To be specific, when a moving target storage volume is a storage volume “22” connected to the I/O interface “50:06:0A:0B:0D:14:02”, writing in a logical storage extent “LDEV-10H” constituting the storage volume is stopped.

The management computer 500 transmits a configuration change request message for moving the storage volume of the moving target to another I/O interface 140 to the storage subsystem 100 (S045). The configuration change request message contains I/O interface identification information of the moving target storage volume, storage volume connection information, and moving destination I/O interface identification information.

Upon reception of the configuration change request message transmitted from the management computer 500, the storage subsystem 100 updates the storage volume configuration information 1005 (S047). As an example, a case where an I/O interface to which the storage volume “22” is connected is changed from “50:06:0A:0B:0C:0D:14:02” to “50:06:0A:0B:0C:0D:14:03” will be considered. In this case, the storage subsystem 100 only needs to update the I/O interface identification information 1005 of a relevant record to “50:06:0A:0C:0D:14:03”.

Upon completion of the updating of the storage volume configuration information 1005, the storage subsystem 100 transmits a configuration change completion message to the management computer 500 (S049).

Upon reception of the configuration change completion message, the management computer 500 updates the configuration information 5003 (S051). To be specific, as in the case of the processing of S047, the storage volume configuration information 1005 contained in the configuration information 5003 is updated.

The management computer 500 refers to the configuration information to obtain a host computer connected to the host computer storage volume of a moving target (S053). To be specific, the management computer 500 retrieves the host computer storage volume configuration information 3001 contained in the configuration information 5003 based on identification information of the storage volume of the moving target. For example, when identification information of the storage volume of the moving target is “22”, host computers 300 connected to the moving target storage volume are “192.168.10.100” and “192.168.10.101” from a value of the host computer identification information 30014 of a relevant record.

The management computer 500 transmits a configuration change request message for moving a connected I/O interface of the storage volume to all the host computers 300 obtained in the processing of S053 (S055).

Upon reception of the configuration change request message, the host computer 300 updates the host computer storage volume configuration information 3001 so that the received moving destination I/O interface can be a connection destination (S057). To be specific, for the storage volume “22” connected to the connected I/O interface “50:06:0A:0B:0C:0D:14:02”, the value of the connected I/O interface identification information 30012 is updated to “50:06:0A:0B:0C:0D:14:03”.

Upon completion of the updating of the host computer storage volume configuration information 3001, the host computer 300 transmits a configuration change processing completion message to the management computer 500 (S059).

Upon reception of the configuration change processing completion message, the management computer 500 updates the configuration information 5003 (S061). To be specific, as in the case of the processing of S057, the host computer storage volume configuration information 3001 contained in the configuration information 5003 is updated. Then, the management computer 500 resumes the writing in the logical storage extent which has been stopped in the processing of S043 (S063).

FIG. 20 is a flowchart showing a procedure of processing of moving the logical storage extent to a different parity group according to the first embodiment. The processing shown in FIG. 20 corresponds to the processing of S027 shown in FIG. 17.

The system administrator inputs a parity group of a moving destination from the input device 570 of the management computer 500 (S065).

The management computer 500 temporarily stops writing to a logical storage extent of a moving target (S067). The management computer 500 transmits a configuration change request message for moving the logical storage extent of the moving target to the designated parity group (S069). The configuration change request message contains identification information of the logical storage extent of the moving target, and moving destination parity group identification information.

Upon reception of the configuration change request message, the storage subsystem 100 moves the moving target logical storage extent to another parity group to update the logical storage extent configuration information 1003 (S071). To be specific, parity group identification information 10033 of a record relevant to the logical storage extent of the moving target is updated to moving destination parity group identification information contained in the received configuration request message. Upon completion of the updating of the logical storage extent configuration information 1003, the storage subsystem 100 transmits a configuration change completion message to the management computer 500 (S073).

Upon reception of the configuration change completion message, the management computer 500 updates the configuration information 5003 (S075). To be specific, as in the case of the processing of S071, the logical storage extent configuration information 1003 contained in the configuration information 5003 is updated. Then, the management computer 500 resumes the writing in the logical storage extent which has been stopped in the processing of S067 (S076).

FIG. 21 is a flowchart showing a procedure of processing of moving a logical storage extent to another physical storage medium according to the first embodiment. The processing shown in FIG. 21 corresponds to the processing of 5039 shown in FIG. 18.

The system administrator inputs a physical storage medium of a moving destination from the input device 570 of the management computer 500 (S077). In this case, by setting a physical storage medium constituting the same physical storage device to be a moving destination, it is possible to reduce an influence of a configuration change.

The management computer 500 temporarily stops writing in a logical storage extent of a moving target (S079). The management computer 500 transmits a configuration change request message for moving the logical storage extent of the moving target to a designated physical storage medium to the storage subsystem 100 (S081). The configuration change request message contains identification information of the moving target logical storage extent, and moving destination physical storage media identification information.

Upon reception of the configuration change request message, the storage subsystem 100 moves the moving target logical storage extent to another physical storage medium to update the logical storage extent configuration information 1003 (S083). To be specific, when the moving target logical storage extent identification information of the configuration change request message is designated to “LDEV-10H” and the moving destination physical storage media identification information is designated to “F023”, a device #2 of the physical storage media identification information 10034 is updated from “F022” to “F023”. Upon completion of the updating of the logical storage extent configuration information 1003, the storage subsystem 100 transmits a configuration change completion message to the management computer 500 (S085).

Upon reception of the configuration change completion message, the management computer 500 updates the configuration information 5003 (S087). To be specific, as in the case of the processing of S083, the logical storage extent configuration information 1003 contained in the configuration information 5003 is updated. Then, the management computer 500 resumes the writing in the logical storage extent which has been stopped in the processing of 5079 (S089).

According to the first embodiment, component performance inspection can be executed by targeting not only the physical storage device but also the physical storage medium constituting the physical storage device. Thus, when the physical storage device is a semiconductor memory device, it is possible to execute performance inspection by a flash memory (storage chip or semiconductor memory) unit which is a physical storage medium.

According to the first embodiment, by correlating the components included in the path from the I/O interface to the flash memory, it is possible to easily execute performance inspection by a series of drill-down operations.

Furthermore, according to the first embodiment, the configuration can be changed by a physical storage medium unit. Thus, an influence range accompanying the configuration change can be reduced as much as possible by limiting the range of the configuration change for performance improvement to the same physical storage device, whereby an influence on a surrounding system environment can be reduced. For example, when a load of the logical storage extent created in the flash memory is large, the logical storage extent can be moved to another flash memory included in the same semiconductor memory device.

### Second Embodiment

The first embodiment has been described by way of the case where the system administrator inputs the physical storage medium of the moving destination or the like. However, a second embodiment will be described by way of a case where a management computer 500 automatically specifies a moving destination. According to the second embodiment, the management computer 500 defines a threshold of a performance load for each component of a performance data observation target, and changes a connection destination to a component of a low performance load when the performance load exceeds the threshold.

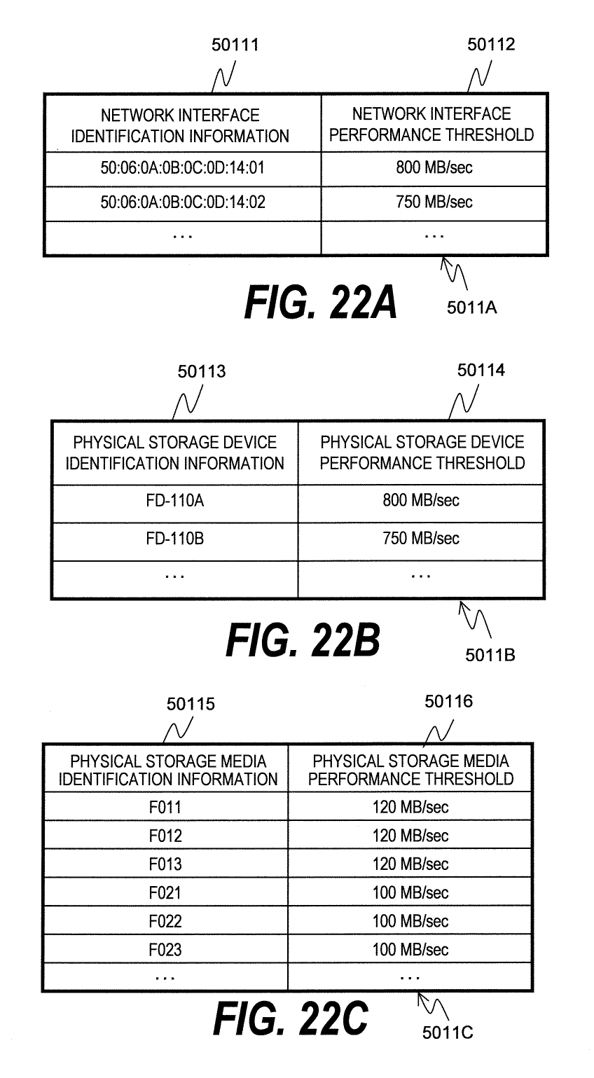

FIG. 22A shows a configuration of performance threshold information 5011A of a network interface according to the second embodiment. The network interface performance threshold information 5011A is used for determining whether a load of the network is excessively large. The network interface performance threshold information 5011A contains network interface identification information 50111 and a network interface performance threshold 50112.

FIG. 22B shows a configuration of performance threshold information 5011B of a physical storage device according to the second embodiment. The physical storage device performance threshold information 5011B is used for determining whether a load of the physical storage device is excessively large. The physical storage device performance threshold information 5011B contains physical storage device identification information 50113 and a physical storage device performance threshold 50114.

FIG. 22C shows a configuration of performance threshold information 5011C of a physical storage medium according to the second embodiment. The physical storage media performance threshold information 5011C is used for determining whether a load of the physical storage medium is excessively large. The physical storage media performance threshold information 5011C contains physical storage media identification information 50115 and a physical storage media performance threshold 50116.

Performance threshold information 1014 stored in a storage subsystem 100 is similar in structure to the performance threshold information 5011 shown in FIG. 22A to FIG. 22C.

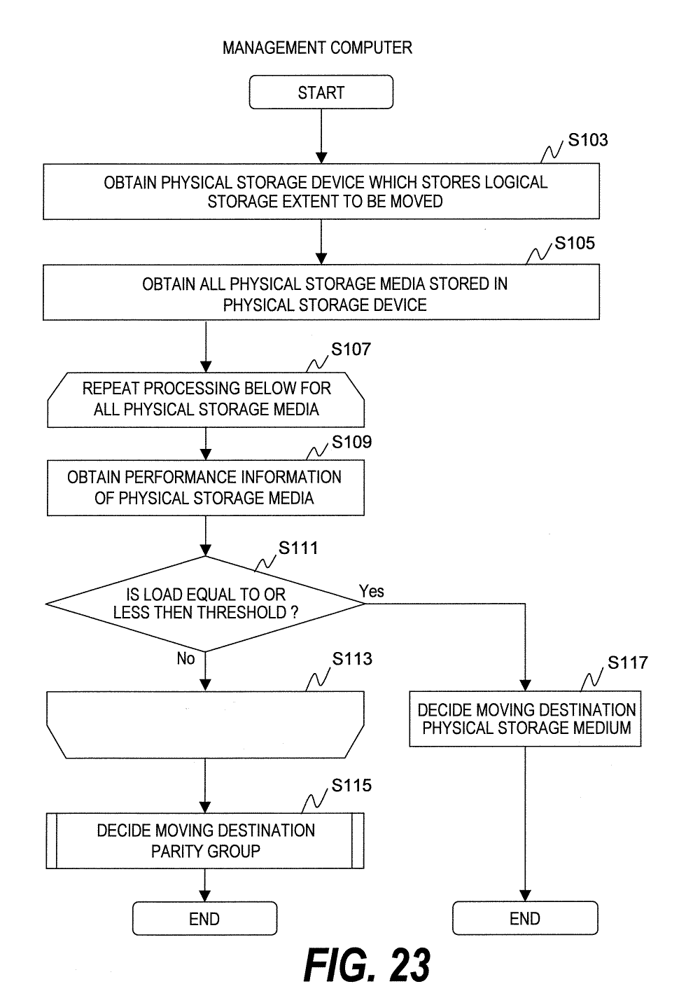

FIG. 23 is a flowchart showing a procedure of automatically specifying a physical storage medium which becomes a moving destination of a logical storage extent by a management computer 500 according to the second embodiment.

After a logical storage extent of a moving target has been decided, the management computer 500 obtains a physical storage device which stores the logical storage extent of the moving target (S103). To be specific, the management computer 500 refers to logical storage extent configuration information 1003 of configuration information 5003 to obtain a parity group based on identification information of the logical storage extent of the moving target. Then, the management computer 500 refers to physical storage extent configuration information 1001 to obtain a physical storage device based on the obtained parity group.

Next, the management computer 500 refers to the physical storage extent configuration information 1001 to obtain all physical storage media stored in the physical storage device (S105). To be specific, the constituting physical storage media are obtained from relevant physical storage device configuration information 1002.

The management computer 500 determines loads of the physical storage media obtained in S105 (S107). To be specific, the processing of S109 and S111 is repeated until a moving destination physical storage medium is decided or determination of loads of all the physical storage media is finished.

The management computer 500 refers to performance information 5007 to obtain performance information of the physical storage media (S109). Subsequently, the management computer 500 calculates an average value of the obtained physical storage media. Then, the management computer 500 determines whether the calculated average value is smaller than a physical storage media performance threshold defined in the performance threshold information 5011C (S111).

When the average value is smaller than the threshold (result of S111 is “Yes”), the management computer 500 decides the obtained physical storage medium as a moving destination (S117). When the average value is larger than the threshold (result of S111 is “No”), another physical storage medium is determined (S113).

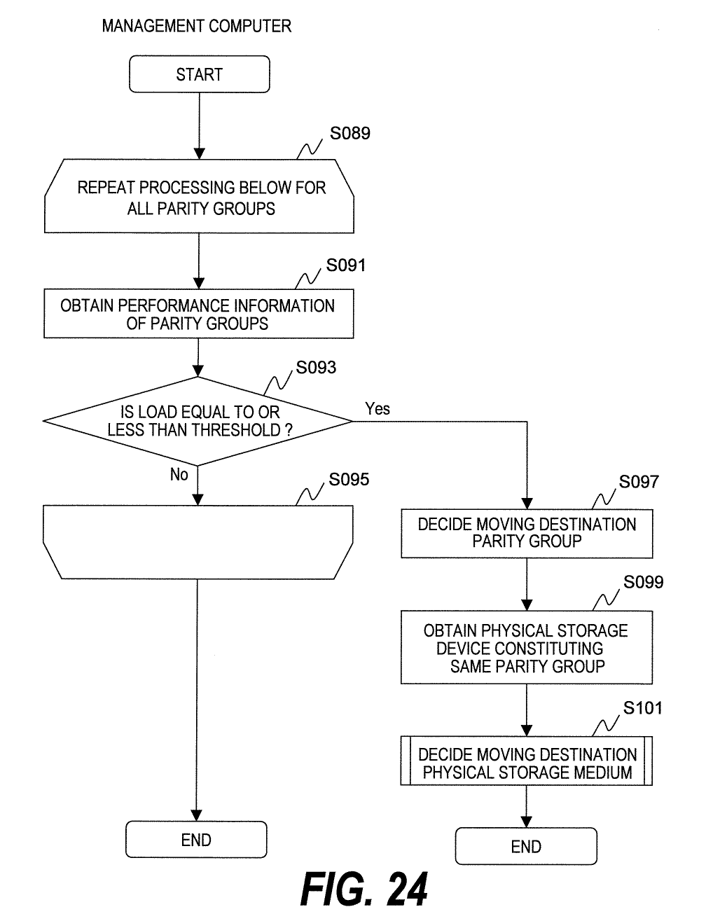

For all the physical storage media obtained in the processing of S105, the management computer 500 executes processing of moving a logical storage extent to another parity group when an average value of performance loads is larger than a threshold (S115). The processing of moving the logical storage extent to another parity group is similar to that shown in FIG. 24 to be described later.

FIG. 24 is a flowchart showing a procedure of processing of automatically specifying a moving destination parity group of the logical storage extent according to the second embodiment of this invention. According to the first embodiment, the parity group of the moving destination is input to be designated by the system administrator. According to the second embodiment, however, a parity group of a moving destination is automatically determined by using the performance threshold information 5011B.

After a logical storage extent of a moving target has been decided, the management computer 500 calculates performance loads of all the parity groups to determine whether they can be moving destinations (S089).

The management computer 500 refers to performance information 5007 to obtain performance information of a parity group to be subjected to performance load determination (S091). Next, the management computer 500 calculates an average value of the obtained performance information. The management computer 500 determines whether the calculated average value is smaller than a parity group performance threshold calculated from the physical storage device performance threshold defined in the performance threshold information 5011 (S093).

When the average value is smaller than the threshold (result of 5093 is “Yes”), the management computer 500 decides the target parity group as a moving destination (S097). When the average value is larger than the threshold (result of 5093 is “No”), the management computer 500 determines another parity group (S095).

The management computer 500 refers to the physical storage extent configuration information 1001 to obtain physical storage devices constituting the parity group (S099). The management computer 500 decides a physical storage medium to be a moving destination of the logical storage extent for each physical storage device (S101). The processing of S101 is similar to that shown in the flowchart shown in FIG. 23.

The procedures shown in the flowcharts shown in FIG. 23 and FIG. 24 can be executed by the storage subsystem 100. The storage subsystem 100 automatically decides a moving destination of the logical storage extent of the moving target, whereby the management computer 500 can move the logical storage extent only by notifying the logical storage extent to the storage subsystem 100.

According to the second embodiment, a threshold of a performance load is defined for each performance data observation target portion to determine whether the performance load is excessively large, whereby the management computer 500 can automatically decide a changing destination of a connection path. Hence, the management computer 500 can reduce the loads of the components which are bottlenecks by monitoring the loads of the performance data target portions without any operations of a system administrator.

1.-17. (canceled)

18. A performance management method for a computer system, the computer system having: a storage subsystem for storing data in a logical storage extent created in at least one physical storage device divided into at least one physical storage medium; a host computer for reading/writing data from/to the logical storage extent of the storage subsystem via a network; and a management computer for managing the storage subsystem, the method comprising:
communicating, by the management computer, with the storage subsystem;
recording, by the management computer, physical storage extent configuration information including components of the storage subsystem that are included in a network path through which the host computer reads/writes the data and a connection relation of the components included in the network path;
recording, by the management computer, logical storage extent configuration information including correspondence between the logical storage extent and the components;
recording, by the management computer, a load of each component of the storage subsystem as performance information for each of the components;
specifying, by the management computer, components included in a path set between an interface of the storage subsystem connected with the network and the non-volatile storage device, based on the physical storage extent configuration information and the logical storage extent configuration information, to measure a load of the logical storage extent;
measuring, by the management computer, loads of the specified components based on the recorded performance information, in order of position from upstream to downstream of the network path; and
measuring, by the management computer, loads of each one of the at least one physical storage medium, if the physical storage medium is flash memory.

19. The performance management method of the computer system according to claim 18, further comprising:
stopping, by the management computer, writing in a logical storage extent diagnosed as exceeding a predetermined load, when the logical storage extent diagnosed as exceeding the predetermined load is moved to another physical storage medium from the physical storage medium;
sending, by the management computer, the storage subsystem notification on a physical storage medium of a moving destination;
moving, by the storage subsystem, the logical storage extent diagnosed as exceeding the predetermined load to the physical storage medium of the moving destination upon reception of the notification on the physical storage medium of the moving destination;
updating, by the management computer, the logical storage extent configuration information with correspondence between the logical storage extent diagnosed as exceeding the predetermined load and the physical storage medium of the moving destination; and
resuming, by the management computer, the writing in the logical storage extent diagnosed as exceeding the predetermined load.

20. The performance management method of the computer system according to claim 18, further comprising:
recording, by the management computer, a performance threshold information of the physical storage medium;
selecting, by the management computer, a physical storage medium of a moving destination to move the logical storage extent diagnosed as exceeding the predetermined load to another physical storage medium when a load of the logical storage extent diagnosed as exceeding the predetermined load is determined as exceeding the performance threshold information; and
the selected physical storage medium of the moving destination is a physical storage medium constituting the same physical storage device as that of a physical storage medium of a moving source, and is selected as a load of the logical storage extent after movement does not exceed the performance threshold information when the logical storage extent diagnosed as exceeding a predetermined load moves.

21. The performance management method of the computer system according to claim 20, further comprising:
moving, by the management computer, the logical storage extent diagnosed as exceeding the predetermined load to a physical storage medium constituting a different physical storage device from including the physical storage medium of the moving source based on the performance information when the physical storage medium of the moving destination of the logical storage extent diagnosed as exceeding the predetermined load cannot be selected in the physical storage medium constituting the same physical storage device as that of the physical storage medium of the moving source.

22. The performance management method of the computer system according to claim 18, further comprising:
displaying, by the management computer, a load of a logical storage extent for each of the physical storage media.

23. A management computer for a computer system, the computer system having: a storage subsystem for storing data in a logical storage extent created in at least one physical storage device divided into at least one physical storage medium; a host computer for reading/writing data from/to the logical storage extent of the storage subsystem via a network; and a management computer for managing and connecting the storage subsystem via a management network, the management computer comprising:
an interface coupled to the management network;
a processor coupled to the interface; and
a memory coupled to the processor,
wherein the processor communicates with the storage subsystem, records physical storage extent configuration information including components of the storage subsystem that are included in a network path through which the host computer reads/writes the data and a connection relation of the components included in the network path, records logical storage extent configuration information including correspondence between the logical storage extent and the components, records a load of each component of the storage subsystem as performance information for each of the components, specifies components included in a path set between the interface connected to the network and the physical storage medium constituting the physical storage device, based on the physical storage extent configuration information and the logical storage extent configuration information, to measure a load state of the logical storage extent, and measures loads of the specified components based on the recorded performance information, in order of position from upstream to downstream of the network path, and to measure loads of each one of the at least one physical storage medium, if the physical storage medium is flash memory.

24. The management computer according to claim 23, wherein the processor stops writing in the logical storage extent diagnosed as exceeding a predetermined load when the logical storage extent diagnosed as exceeding the predetermined load is moved to another physical storage medium, sends the storage subsystem notification on a physical storage medium of a moving destination, updates the logical storage extent configuration information with correspondence between the logical storage extent diagnosed as exceeding the predetermined load and stored in the logical storage extent configuration information and the components upon reception of a notification of completion of the movement of the logical storage extent diagnosed as exceeding the predetermined load, and resumes the writing in the logical storage extent diagnosed as exceeding the predetermined load.

25. The management computer according to claim 23, wherein:
the memory records a performance threshold information of the physical storage medium;
the processor selects a physical storage medium of a moving destination to move the logical storage extent diagnosed as exceeding the predetermined load to another physical storage medium when a load of the logical storage extent diagnosed as exceeding the predetermined load is determined as exceeding the performance threshold information; and
the selected physical storage medium of the moving destination is a physical storage medium constituting the same physical storage device as that of a physical storage medium of a moving source, and is selected as a load of the logical storage extent after movement does not exceed the performance threshold information when the logical storage extent diagnosed as exceeding a predetermined load moves.

26. The management computer according to claim 25, wherein the processor moves the logical storage extent diagnosed as exceeding the predetermined load to a physical storage medium constituting a different physical storage device from including the physical storage medium of the moving source based on the performance information when the physical storage medium of the moving destination of the logical storage extent diagnosed as exceeding the predetermined load to the physical storage medium constituting the same physical storage device as that of the physical storage medium of the moving source.

27. The management computer according to claim 23, wherein the processor displays a load of a logical storage extent for each of the physical storage media.

28. A storage subsystem implemented in a computer system, the computer system having: the storage subsystem for storing data in a logical storage extent created in a physical storage device constituted of a physical storage medium; and a host computer for reading/writing data from/to the logical storage extent of the storage subsystem via a network, the storage subsystem comprising:
an interface coupled to the network;
a processor coupled to the interface; and
a memory coupled to the processor,
wherein the processor records physical storage extent configuration information including components of the storage subsystem that are included in a network path through which the host computer reads/writes the data recorded in the logical storage extent and a connection relation of the components included in the network path, records logical storage extent configuration information including correspondence between the logical storage extent and the components, receives components of a moving destination when the logical storage extent is moved to other components, and moves the logical storage extent to be moved to the components of the moving destination based on the physical storage extent configuration information and the logical storage extent configuration information.

29. The storage subsystem according to claim 28, wherein the processor stops writing in the logical storage extent to be moved when the logical storage extent is moved to the other components, moves the logical storage extent to be moved to the components of the moving destination, updates the logical storage extent configuration information with correspondence between the logical storage extent to be moved and the components of the moving destination, and resumes the writing in the logical storage extent to be moved.

30. The storage subsystem according to claim 28, wherein:
the processor stores a load of each component as performance information, stores a performance threshold information of the components, and selects a physical storage medium of a moving destination to move the logical storage extent to be moved to another physical storage medium when a load of the logical storage extent to be moved is determined as exceeding the performance threshold information; and
the selected physical storage medium of the moving destination is a physical storage medium constituting the same physical storage device as that of a physical storage medium of a moving source, and is selected as a load of the logical storage extent after movement does not exceed the performance threshold information when the logical storage extent to be moved moves.

31. The storage subsystem according to claim 30, wherein the processor moves the logical storage extent to be moved to a physical storage medium constituting a different physical storage device from including the physical storage medium of the moving source based on the performance information when the physical storage medium of the moving destination of the logical storage extent to be moved to the physical storage medium constituting the same physical storage device as that of the physical storage medium of the moving source.
